(19) United States
(12) Patent Application Publication
(10) Pub. No.: US 2020/0007182 A1
(43) Pub. Date: Jan. 2, 2020

(54) Bulletproof Tablet Protective Case

(71) Applicant: Wing Tak Lee Silicone Rubber Technology (Shenzhen) Co., Shenzhen Guangdong (CN)

(72) Inventor: Tak Nam Liu, Shenzhen Guangdong (CN)

(73) Assignee: Wing Tak Lee Silicone Rubber Technology (Shenzhen) Co., Shenzhen Guangdong (CN)

(21) Appl. No.: 16/103,335

(22) Filed: Aug. 14, 2018

(30) Foreign Application Priority Data
Jun. 29, 2018 (CN) 201810691963.9

(51) Int. Cl. H04B 1/3888; F41H 5/04; G06F 1/16

(52) U.S. Cl. CPC H04B 1/3888; A45C 2011/003; G06F 1/1613; F41H 5/0407

(57) ABSTRACT

The present application provides a bulletproof tablet protective case, which comprises a tablet protective case and a sandwich layer provided at the bottom layer of the tablet protective case, wherein a plurality layers of bulletproof fiber cloths are fixedly provided in the sandwich layer; and bulletproof glass is provided in the rear camera opening of the tablet protective case. The bulletproof tablet protective case of the present application has the advantage of high security.

### CROSS REFERENCE TO RELATED APPLICATION

The present application claims priority to Chinese patent application No. 201810691963.9, entitled “Bulletproof Tablet Protective Case”, filed on Jun. 28, 2018, the entire content of which is incorporated herein by reference.

### TECHNICAL FIELD

The present application relates to the field of daily necessities and electronic accessories, and in particular to a bulletproof tablet protective case.

### BACKGROUND

Guns are very dangerous weapons. China has strict control over guns. However, guns are not controlled in some countries, such as the United States. Therefore, there are frequent shooting incidents in the United States. If a shooting incident occurs, the masses have no daily necessities to withstand the shooting currently, which leads to the masses having no protective measures during the shooting.

A tablet, such as ipad, has become the most commonly used device for users. Because the area of a tablet is larger than that of a mobile phone, the tablet can play a certain role of being bulletproof if its protective case is effectively bulletproof. The existing ipad protective case just protects the iPad, but does not provide a bulletproof function, so the security is low.

### SUMMARY

An embodiment of the present application provides a bulletproof tablet protective case, which may be bulletproof with the help of the tablet protective case and has the advantage of improving the security of a user.

In the first aspect, an embodiment of the present application provides a bulletproof tablet protective case, which comprises a tablet protective case and a sandwich layer provided at the bottom layer of the tablet protective case.

In particular, a plurality layers of bulletproof fiber cloths are fixedly provided in the sandwich layer; and bulletproof glass is provided in the rear camera opening of the tablet protective case.

Preferably, the bulletproof fiber cloth comprises: a graphene fiber cloth or an aramid fiber fabric.

Preferably, each of the plurality layers of bulletproof fiber cloths consists of a plurality of diamond-shaped reinforcing units, wherein an included angle is formed between the two neighboring diamond-shaped reinforcing units of the adjacent bulletproof fiber cloths.

Preferably, the diamond-shaped reinforcing unit has an angle of a diamond shape of 60°, 120°, 60°, 120°, and an included angle of 30° is formed between the diamond-shaped reinforcing units of the adjacent bulletproof fiber cloths.

Preferably, the bulletproof tablet protective case further comprises: a sliding rail which is provided corresponding to the bulletproof glass, and the bulletproof glass is slidable on the sliding rail.

The embodiment of the present application is implemented with the following beneficial effects.

It can be seen that, according to the embodiment of the present application, a sandwich layer is provided at the bottom of the backpack, and a plurality layers of bulletproof fiber cloths are provided in the sandwich layer so as to be bulletproof so that it has the advantage of high security.

### BRIEF DESCRIPTION OF THE DRAWINGS

In order to more clearly illustrate the technical solutions in the embodiments of the present application, the drawings to be used in the description of the embodiments will be briefly described below. It is obvious that the drawings in the following description are some embodiments of the present application. Those skilled in the art may also obtain other drawings based on these drawings without paying creative work.

FIG. 1 is a schematic diagram illustrating the structure of a bulletproof tablet protective case according to the present application.

FIG. 2 is a schematic diagram illustrating the structure of a bulletproof fiber cloth according to the present application.

FIG. 3 is a schematic diagram illustrating the angle of a diamond-shaped reinforcing block of a 2-layer bulletproof fiber cloth according to the present application.

### DESCRIPTION OF THE EMBODIMENTS

The technical solutions of the embodiments of the present application will be described clearly and fully below in combination with drawings in the embodiments of the present application. It is apparent that the described embodiments are merely part of embodiments of the present application rather than all embodiments. Other embodiments achieved by those skilled in the art based on the embodiments in the present application without paying creative work will also fall into the scope of protection of the present application.

The term such as “first,” “second,” “third” and “fourth” in the description and claims of the present application and the drawings is used to distinguish different objects, rather than describe a specific order. Furthermore, the term such as “comprising”, “having” or any variation thereof is intended to encompass non-exclusive inclusion. For example, a process, method, system, product, or device including a series of steps or units is not limited to the listed steps or units, but may further include steps or units not listed, or Preferably further includes other steps or units inherent to such a process, method, product, or device.

References to “embodiment” herein mean that a particular feature, result, or characteristic described in connection with the embodiments may be included in at least one embodiment of the present application. This term existing at various positions in the specification does not necessarily refer to the same embodiment, and is not an independent or alternative embodiment that is mutually exclusive from other embodiments. Those skilled in the art will explicitly and implicitly understand that the embodiments described herein may be combined with other embodiments.

Referring to FIG. 1, FIG. 1 is a schematic diagram illustrating the structure of a bulletproof tablet protective case. As shown in FIG. 1, the bulletproof tablet protective case comprises: a tablet protective case 10 and a sandwich layer provided at the bottom layer of the tablet protective case 10.

In particular, a plurality layers of bulletproof fiber cloths are fixedly provided in the sandwich layer; and bulletproof glass 11 is provided in the rear camera opening of the tablet protective case 10.

According to the embodiment of the present application, a sandwich layer is provided at the bottom of the protective case, and a plurality of layers of bulletproof fiber cloths are provided in the sandwich layer so as to have the function of being bulletproof. In addition, since the position of the rear camera is required to be photographed by the camera and the bulletproof fiber cloths cannot be provided, the bulletproof glass is provided at this position, so that it has the advantage of high security.

Preferably, the above bulletproof fiber cloth comprises, but is not limited to, a graphene fiber cloth or an aramid fiber fabric. Of course, in practical applications, the bulletproof fiber cloth provided by the present application may also be of other materials, and the present application does not limit the above bulletproof fiber cloth.

Preferably, each layer of the plurality of layers of bulletproof fiber cloths consists of a plurality of diamond-shaped reinforcing units 30, wherein an included angle is formed between two neighboring diamond-shaped reinforcing units of the adjacent bulletproof fiber cloths.

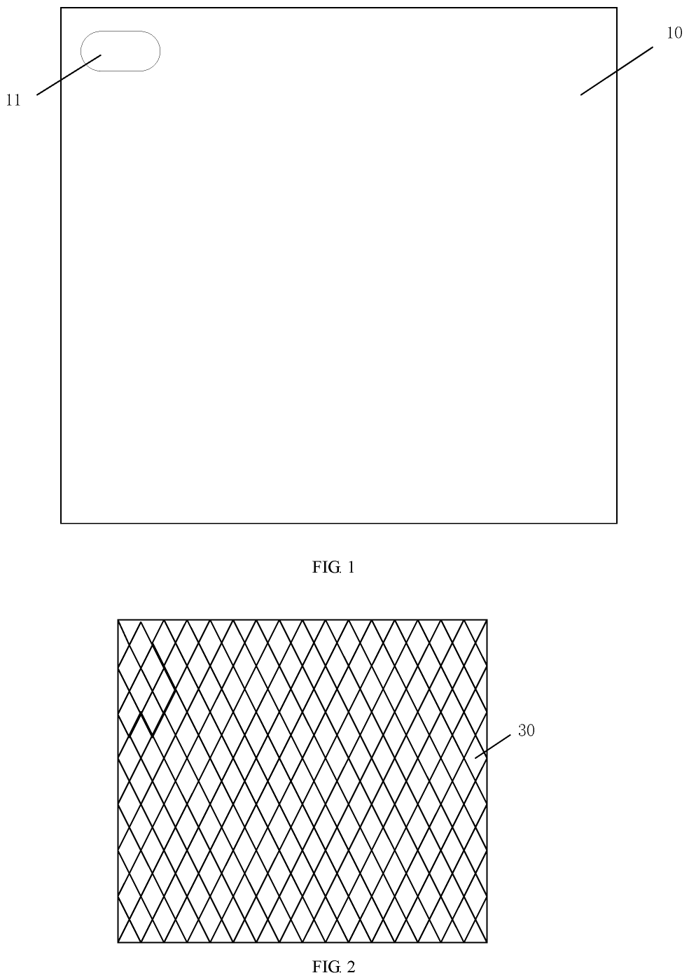

The plurality of diamond-shaped reinforcing units are provided to improve the bulletproof performance of the bulletproof fiber cloth. As shown in FIG. 2, the bulletproof fiber cloth may comprise a plurality of diamond-shaped reinforcing units. The diamond-shaped reinforcing units are provided to effectively relieve the impact of the bullet, especially to better relieve the rotary impact of the bullet, but the disadvantage is: for the edge position (i.e., four sides) of the diamond-shaped reinforcing unit 30, the structure is relatively weak. In order to solve this problem, the inventor has shifted the plurality of layers of bulletproof fibers by an angle, accordingly no matter what position the bullet hits, there are more diamond-shaped reinforcing units to weaken the impact of the bullet so that the entire bulletproof fiber cloth relieves the impact of the bullet and the bulletproof effect is improved.

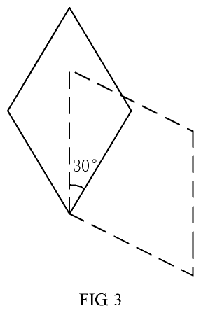

Preferably, referring to FIG. 3, the above diamond-shaped reinforcing unit has an angle of a diamond shape of 60°, 120°, 60°, 120°, and an angle of 30° is formed between the diamond-shaped reinforcing units between the adjacent layers.

With this configuration, each diamond-shaped side line may be located in the center of the diamond-shaped reinforcing block of the adjacent layers. The center position can effectively improve the bulletproof ability of the diamond-shaped reinforcing block, which can achieve the level of a bulletproof for 9 mm gun. That is, the bulletproof level can be Level I, Level II A, or Level II, which is effectively bulletproof.

Preferably, a sliding rail is provided corresponding to the above camera opening. The bulletproof glass is slidable with the sliding rail. This configuration enables the camera user to better display the effect. Although the bulletproof glass is transparent, the bulletproof glass will refract a light ray, which affects the effect of photographing. Therefore, the inventor provides a sliding rail so that the user can slide the bulletproof glass to one side when photographing so that the bulletproof effect can be ensured and the photographing effect can also be improved.

In the above embodiments, the various embodiments are described in different focuses, and the parts that are not detailed in a certain embodiment may refer to the related descriptions of other embodiments.

In the several embodiments provided by the present application, it should be understood that the disclosed device may be implemented in other ways. For example, the device embodiments described above are merely illustrative. For example, the division of the unit is only a logical function division. In actual implementation, there may be another division manner. For example, a plurality of units or components may be combined or integrated into another system, or some features may be ignored or not implemented. In addition, the illustrated or discussed mutual coupling or direct coupling or communication connection may be indirect coupling or communication connection through some interfaces, devices or units, and may be electrical or in other forms.

In addition, each functional unit in each embodiment of the present application may be integrated in one processing unit, or each unit may exist alone physically, or two or more units may be integrated in one unit. The above integrated unit may be implemented in the form of hardware or in the form of software program modules.

The embodiments of the present application have been described in detail above. Specific examples are used herein to set forth the principles and the embodiments of the present application, and the descriptions of the above embodiments are only meant to help understanding of the method and the core idea of the present application. Meanwhile, those skilled in the art may make alterations to the specific embodiments and the scope of application in accordance with the idea of the present application. In conclusion, the contents of the present specification shall not be interpreted as limiting to the present application.

What is claimed is:

1. A bulletproof tablet protective case, comprising: a tablet protective case and a sandwich layer provided at the bottom layer of the tablet protective case, wherein a plurality layers of bulletproof fiber cloths are fixedly provided in the sandwich layer; and a bulletproof glass is provided in the rear camera opening of the tablet protective case.

2. The bulletproof tablet protective case of claim 1, wherein the bulletproof fiber cloth comprises a graphene fiber cloth or an aramid fiber fabric.

3. The bulletproof tablet protective case of claim 1, wherein each of the plurality layers of bulletproof fiber cloths consists of a plurality of diamond-shaped reinforcing units, wherein an included angle is formed between two neighboring diamond-shaped reinforcing units of the adjacent bulletproof fiber cloths.

4. The bulletproof tablet protective case of claim 3, wherein the diamond-shaped reinforcing unit has an angle of a diamond shape of 60°, 120°, 60°, 120°, and an included angle of 30° is formed between the diamond-shaped reinforcing units of the adjacent bulletproof fiber cloths.

5. The bulletproof tablet protective case of claim 1, wherein the bulletproof tablet protective case further comprises a sliding rail, which is provided corresponding to the bulletproof glass, and the bulletproof glass is slidable on the sliding rail.
